(19) United States
(12) Patent Application Publication
(10) Pub. No.: US 2010/0328176 A1
(43) Pub. Date: Dec. 30, 2010

(54) ANTENNA MODULE AND DESIGN METHOD THEREOF

(75) Inventors: Yi-Cheng Lin, Taipei City (TW); Yi-Chia Chen, Taipei City (TW); Yi-Fong Lu, Taipei City (TW)

Correspondence Address: QUINTERO LAW OFFICE, PC, 615 Hampton Dr, Suite A202, Venice, CA, 90291, US

(73) Assignee: NATIONAL TAIWAN UNIVERSITY, TAIPEI (TW)

(21) Appl. No.: 12/553,816

(22) Filed: Sep. 3, 2009

(30) Foreign Application Priority Data
Jun. 25, 2009 (TW) TW098121311

(51) Int. Cl. H01Q 19/10; G06F 17/50

(52) U.S. Cl. 343/834; 716/100

(57) ABSTRACT

An antenna module is provided. The antenna module includes a reflective superstrate, an antenna substrate, an antenna and a reflective pattern. The antenna is disposed on the antenna substrate. The reflective pattern is formed on the reflective superstrate, wherein a reflection gap is formed between the reflective superstrate and the antenna substrate. The reflective pattern provides a first reflection phase angle, the antenna substrate provides a second reflection phase angle, the first reflection phase angle includes a first determined phase angle Δ₁, the first determined phase angle Δ₁ is not 0°, the first reflection phase angle is about −(180°−Δ₁), the second reflection phase angle includes a second determined phase angle Δ₂, the second reflection phase angle is about −(180°−Δ₂), a dimension of the reflection gap is directly proportional to a total predetermined phase angle Δ=Δ₁+Δ₂, and the total predetermined phase angle is between 0°˜90°.

### CROSS REFERENCE TO RELATED APPLICATIONS

This Application claims priority of Taiwan Patent Application No. 098121311, filed on Jun. 25, 2009, the entirety of which is incorporated by reference herein.

### BACKGROUND OF THE INVENTION

1. Field of the Invention

The present invention relates to an antenna module, and in particular relates to an antenna module having an Electromagnetic Band Gap cover.

2. Description of the Related Art

FIG. 1a shows a conventional antenna module 1, comprising a cover 10, an antenna substrate 20 and an antenna 30. The antenna 30 provides a wireless signal 2. The cover 10 increases reflection times of the wireless signal 2 to increase the energy intensity thereof. The cover 10 has a first reflection phase angle Φ₁, and the antenna substrate 20 has a second reflection phase angle Φ₂. The first reflection phase angle Φ₁ is about −180°. The second reflection phase angle Φ₂ is about −180°. To regulate the reflected wireless signal 2 in phase, a formula (A) is utilized:

$$- ( \frac{360}{λ} d 1 \times 2 ) + {φ}_{1} + {φ}_{2} = - 360 \times N \qquad ( A )$$

According to the formula (A), a distance d1 between the cover 10 and the antenna substrate 20 is at least equal to half of a wavelength of the wireless signal 2.

FIG. 1b shows another conventional antenna module 1′, comprising a cover 10, an antenna substrate 20′ and an antenna 30. The antenna 30 provides a wireless signal 2. The cover 10 increases reflection times of the wireless signal 2 to increase the energy intensity thereof. The cover 10 has a first reflection phase angle Φ₁, and the antenna substrate 20′ has a second reflection phase angle Φ₂′. The first reflection phase angle Φ₁ is about −180°. The second reflection phase angle Φ₂′ is about 0°. To regulate the reflected wireless signal 2 in phase, a distance d2 between the cover 10 and the antenna substrate 20′ is at least equal to a quarter of a wavelength of the wireless signal 2.

Conventionally, the distance between the cover 10 and the antenna substrate 20(20′) is large, and the volume of the antenna module is thus large.

### BRIEF SUMMARY OF THE INVENTION

A detailed description is given in the following embodiments with reference to the accompanying drawings.

An antenna module is provided. The antenna module comprises a reflective superstrate, an antenna substrate, an antenna and a reflective pattern. The antenna is disposed on the antenna substrate. The reflective pattern is formed on the reflective superstrate, wherein a reflection gap is formed between the reflective superstrate and the antenna substrate. The reflective pattern provides a first reflection phase angle, the antenna substrate provides a second reflection phase angle, the first reflection phase angle comprises a first determined phase angle Δ₁, the first determined phase angle Δ₁ is not 0°, the first reflection phase angle is about −(180°−Δ₁), the second reflection phase angle comprises a second determined phase angle Δ₂, the second reflection phase angle is about −(180°−Δ₂), a dimension of the reflection gap is directly proportional to a total predetermined phase angle Δ=Δ₁+Δ₂, and the total predetermined phase angle is between 0°˜90°.

The antenna module of the embodiment provides return loss bandwidth of 23.59%, realized gain of 11.14 dBi and pure polarization. The antenna module of the embodiment is a wide bandwidth, high gain, and high cross polarization isolation antenna module.

### BRIEF DESCRIPTION OF THE DRAWINGS

The present invention can be more fully understood by reading the subsequent detailed description and examples with references made to the accompanying drawings, wherein:

FIG. 1a shows a conventional antenna module;

FIG. 1b shows another conventional antenna module;

FIG. 2 shows an antenna module of the embodiment of the invention;

FIG. 3 shows the reflective pattern and the antenna of one embodiment of the invention;

FIG. 4a shows the return loss of the antenna module of the embodiment of the invention when compared to a simple Patch Antenna;

FIG. 4b shows the realized gain of the antenna module of the embodiment of the invention when compared to a simple Patch Antenna;

FIG. 4c shows the realized gain pattern on XZ plane of the antenna module when transmitting a wireless signal of 5.2 GHz;

FIG. 4d shows the realized gain pattern on YZ plane of the antenna module when transmitting a wireless signal of 5.2 GHz; and

FIG. 5 shows an antenna module of another embodiment of the invention.

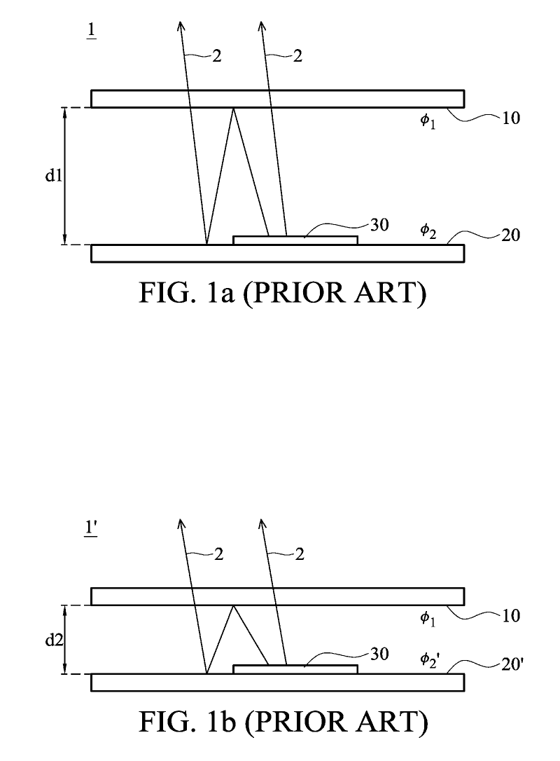

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

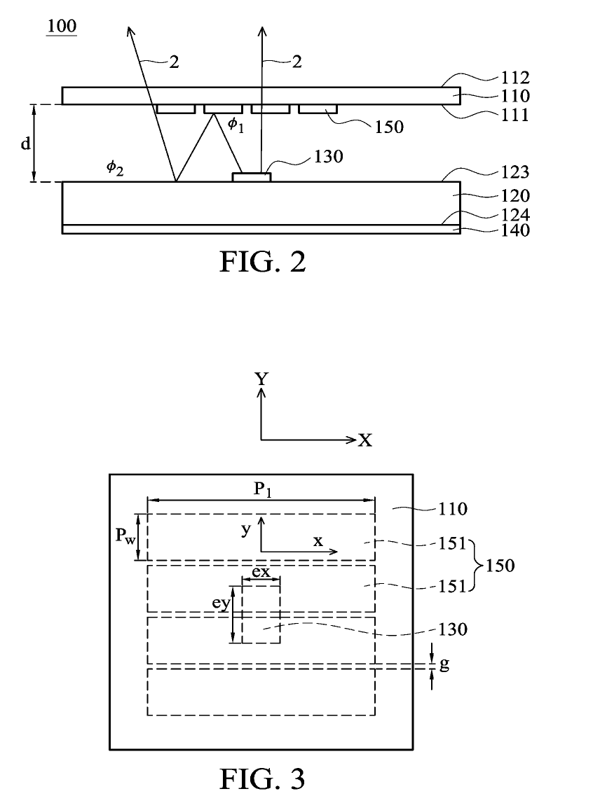

FIG. 2 shows an antenna module 100 of the embodiment of the invention, comprising a reflective superstrate 110, an antenna substrate 120, an antenna 130, a ground layer 140 and a reflective pattern 150. The reflective superstrate 110 is a partial reflective superstrate, comprising a first surface 111 and a second surface 112. The first surface 111 is opposite to the second surface 112. The antenna substrate 120 has a third surface 123 and a fourth surface 124. The third surface 123 is opposite to the fourth surface 124. The antenna 130 is disposed on the third surface 123. The ground layer 140 is disposed on the fourth surface 124. The reflective pattern 150 is formed on the first surface 111. The reflective pattern 150 is corresponding to the antenna 130. A reflection gap d is formed between the first surface 111 and the third surface 123. The reflective pattern 150 provides a first reflection phase angle Φ₁, and the third surface provides a second reflection phase angle Φ₂. The first reflection phase angle Φ₁ comprises a first determined phase angle Δ₁. The first determined phase angle Δ₁ is not 0°. The first reflection phase angle Φ₁ is about −(180°−Δ₁). The second reflection phase angle Φ₂ comprises a second determined phase angle Δ₂. The second reflection phase angle Φ₂ is about −(180°−Δ₂). A dimension of the reflection gap is directly proportional to a total predetermined phase angle Δ=Δ₁+Δ₂, and the total predetermined phase angle is between 0°˜90°.

The embodiment designs the first determined phase angle Δ₁ by modifying the reflective pattern 150. The second determined phase angle Δ₂ can be designed by choosing material (dielectric coefficient) and thickness of the antenna substrate 120. According to the Formulas (B1) and (B2):

$$\begin{matrix}- ( \frac{360}{λ} d \times 2 ) + {φ}_{1} + {φ}_{2} = 360 \times 1 & ( B 1 ) \\ ( \frac{360}{λ} d \times 2 ) = Δ & ( B 2 )\end{matrix}$$

Therefore, the dimension of the reflection gap d is directly proportional to the total predetermined phase angle Δ=Δ₁+Δ₂. The total predetermined phase angle Δ is designed by modifying the first determined phase angle Δ₁ (reflective pattern) and the second determined phase angle Δ₂ (antenna substrate). The reflection gap d can be minimized by modifying the total predetermined phase angle Δ, and the volume of the antenna module 100 is decreased.

The material of the reflective superstrate 110 and the antenna substrate 120 can be dielectric material. The reflection gap d can be an empty space (filled by air), or filled by dielectric material.

In one embodiment of the invention, the total predetermined phase angle Δ is not 0°. The total predetermined phase angle is between 0°˜90°, is preferred between 0°˜60°, and is further preferred between 0°˜20°.

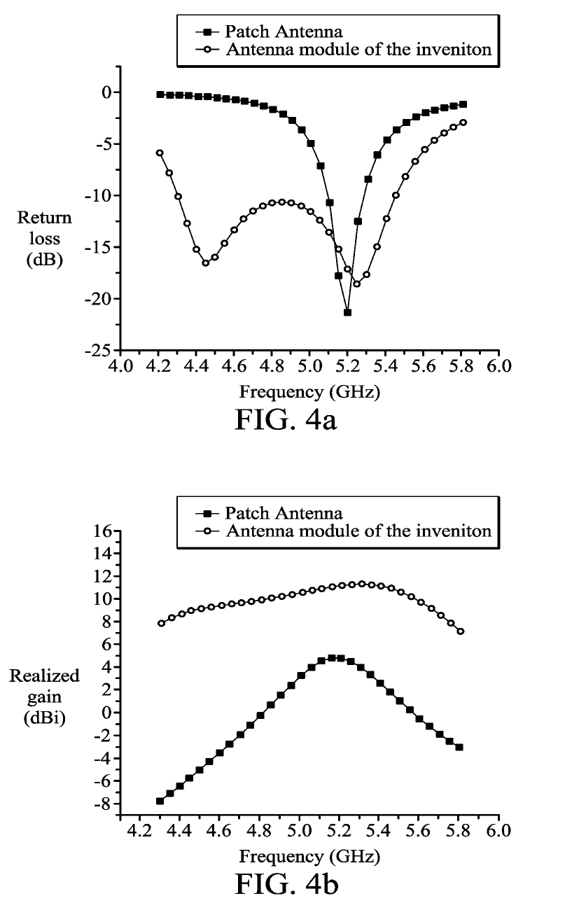

FIG. 3 shows the reflective pattern 150 and the antenna 130 of one embodiment of the invention. The reflective pattern 150 comprises a plurality of reflective units 151. Each reflective unit 151 comprises a major axis x and a minor axis y. The reflective units 151 are equidistantly arranged along a first direction Y, and the minor axes y of the reflective units 151 are parallel to the first direction Y. In this embodiment, the reflective units are rectangular, and the reflective units are arranged into a 4×1 matrix. A unit gap g is formed between contiguous reflective units. The total predetermined phase angle Δ is about ±20°, a length P₁ of the reflective unit 151 is 50 mm, a width P_{w} of the reflective unit 151 is 11.975 mm, the unit gap g is 0.7 mm, a width ex of the antenna 130 is 8.5 mm, a length ey of the antenna 130 is 14.54 mm, and the reflection gap d is 1 mm.

In the embodiment above, the first determined phase angle Δ₁ can be designed by modifying the length P₁ of the reflective unit, the width P_{w} of the reflective unit, and the unit gap g.

In the embodiment, the antenna 130 is a Patch Antenna, providing a wireless signal 2, wherein the wireless signal comprises a major polarization direction and a cross polarization direction, and the first direction Y is parallel to the major polarization direction.

In the embodiment, the antenna is a Patch Antenna, but the invention is not limited thereto. The antenna can also be a slot antenna or other antenna design.

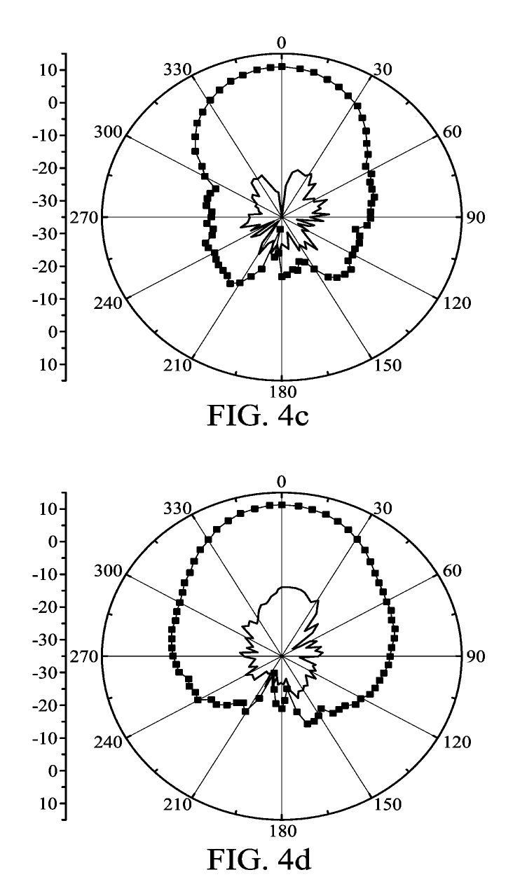

FIG. 4a shows the return loss of the antenna module 100 of the embodiment of the invention when compared to a simple Patch Antenna. As shown in FIG. 4a, the antenna module 100 of the embodiment of the invention has greater bandwidth.

FIG. 4b shows the realized gain of the antenna module 100 of the embodiment of the invention when compared to a simple Patch Antenna. As shown in FIG. 4b, the antenna module 100 of the embodiment of the invention has increased realized gain.

FIG. 4c shows the realized gain pattern on XZ plane of the antenna module 100 when transmitting a wireless signal of 5.2 GHz. FIG. 4d shows the realized gain pattern on YZ plane of the antenna module 100 when transmitting a wireless signal of 5.2 GHz. As shown in FIGS. 4c and 4d, the antenna module 100 of the embodiment provides improved directivity and cross polarization isolation.

The antenna module of the embodiment provides return loss bandwidth of 23.59%, realized gain of 11.14 dBi and pure polarization. The antenna module of the embodiment is a high bandwidth, high gain, and high cross polarization isolation antenna module.

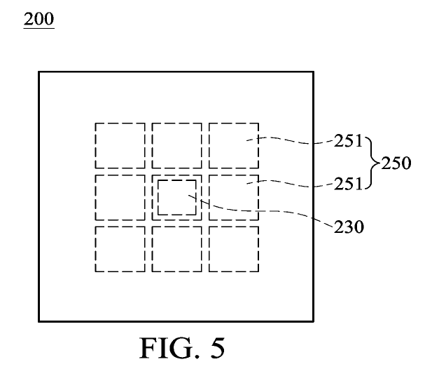

FIG. 5 shows an antenna module 200 of another embodiment of the invention, wherein the reflective pattern 250 comprises a plurality of reflective units 251. The reflective units 251 are square, and equidistantly arranged into a phalanx. In this embodiment, the antenna 230 is a Patch Antenna.

The reflective pattern mentioned above is an Electromagnetic Band Gap pattern. The reflective pattern can be modified.

In the embodiment of the invention, the dimension of the reflection gap can be first determined, then the total predetermined phase angle Δ is achieved according to the dimension of the reflection gap. Then, the reflective pattern and the antenna substrate are designed accordingly. Or, the total predetermined phase angle Δ is first determined, then the dimension of the reflection gap is achieved according to the total predetermined phase angle Δ. Then, the reflective pattern and the antenna substrate are designed accordingly.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna module, comprising:
a reflective superstrate, comprising a first surface and a second surface, wherein the first surface is opposite to the second surface;
an antenna substrate, comprising a third surface and a fourth surface, wherein the third surface is opposite to the fourth surface;
an antenna, disposed on the third surface; and
a reflective pattern, formed on the first surface and facing the antenna, wherein a reflection gap is formed between the first surface and the third surface, the reflective pattern provides a first reflection phase angle, the third surface provides a second reflection phase angle, the first reflection phase angle comprises a first determined phase angle Δ₁, the first determined phase angle Δ₁ is not 0°, the first reflection phase angle is about −(180°−Δ₁), the second reflection phase angle comprises a second determined phase angle Δ₂, the second reflection phase angle is about −(180°−Δ₂), a dimension of the reflection gap is directly proportional to a total predetermined phase angle Δ=Δ₁+Δ₂, and the total predetermined phase angle is between 0°˜90°.

2. The antenna module as claimed in claim 1, wherein the total predetermined phase angle is between 0°−60°.

3. The antenna module as claimed in claim 1, wherein the total predetermined phase angle is between 0°−20°.

4. The antenna module as claimed in claim 1, wherein the reflective pattern comprises a plurality of reflective units, each reflective unit comprises a major axis and a minor axis, the reflective units are equidistantly arranged along a first direction, and the minor axes of the reflective units are parallel to the first direction.

5. The antenna module as claimed in claim 4, wherein the reflective units are rectangular.

6. The antenna module as claimed in claim 4, wherein a unit gap is formed between contiguous reflective units.

7. The antenna module as claimed in claim 4, wherein the antenna provides a wireless signal, and the wireless signal comprises a major polarization direction and a cross polarization direction, and the first direction is parallel to the major polarization direction.

8. The antenna module as claimed in claim 4, wherein the reflective units are arranged into a 4×1 matrix.

9. The antenna module as claimed in claim 1, wherein the reflective pattern comprises a plurality of reflective units, and the reflective units are square.

10. The antenna module as claimed in claim 9, wherein the reflective units are equidistantly arranged into a phalanx.

11. The antenna module as claimed in claim 1, further comprising a ground layer, disposed on the fourth surface.

12. The antenna module as claimed in claim 1, wherein a dielectric material is filled in the reflective gap.

13. A design method of an antenna module, comprising:
providing a reflective superstrate, an antenna substrate, an antenna and a reflective pattern, wherein the reflective superstrate comprises a first surface and a second surface, the first surface is opposite to the second surface, the antenna substrate comprises a third surface and a fourth surface, the third surface is opposite to the fourth surface, the antenna is disposed on the third surface, the reflective pattern is formed on the first surface and facing the antenna, a reflection gap is formed between the first surface and the third surface, the reflective pattern provides a first reflection phase angle, and the third surface provides a second reflection phase angle;
determining a first determined phase angle Δ₁ of the first reflection phase angle and a second determined phase angle Δ₂ of the second reflection phase angle, wherein the first determined phase angle Δ₁ is not 0°, the first reflection phase angle is about −(180°−Δ₁), the second reflection phase angle is about −(180°−Δ₂), a total predetermined phase angle Δ=Δ₁+Δ₂ is between 0°−90°, and a dimension of the reflection gap is achieved according to the total predetermined phase angle Δ; and
designing the reflective pattern.

14. The design method as claimed in claim 13, wherein the reflective pattern comprises a plurality of reflective units, each reflective unit comprises a major axis and a minor axis, the reflective units are equidistantly arranged along a first direction, and the minor axes of the reflective units are parallel to the first direction.

15. The design method as claimed in claim 14, wherein the reflective units are rectangular.

16. The design method as claimed in claim 14, wherein a unit gap is formed between contiguous reflective units.

17. The design method as claimed in claim 14, wherein the antenna provides a wireless signal, the wireless signal comprises a major polarization direction and a cross polarization direction, and the first direction is parallel to the major polarization direction.

18. The design method as claimed in claim 13, wherein the reflective pattern comprises a plurality of reflective units, and the reflective units are squared.

19. The design method as claimed in claim 18, wherein the reflective units are equidistantly arranged into a phalanx.

20. A design method of an antenna module, comprising:
providing a reflective superstrate, an antenna substrate, an antenna and a reflective pattern, wherein the reflective superstrate comprises a first surface and a second surface, the first surface is opposite to the second surface, the antenna substrate comprises a third surface and a fourth surface, the third surface is opposite to the fourth surface, the antenna is disposed on the third surface, the reflective pattern is formed on the first surface and facing the antenna, a reflection gap is formed between the first surface and the third surface, the reflective pattern provides a first reflection phase angle, and the third surface provides a second reflection phase angle;
determining a dimension of the reflection gap;
determining a total predetermined phase angle Δ according to the dimension of the reflection gap, wherein the first reflection phase angle comprises a first determined phase angle Δ₁, the second reflection phase angle comprises a second determined phase angle Δ₂, the first determined phase angle Δ₁ is not 0°, the first reflection phase angle is about −(180°−Δ₁), the second reflection phase angle is about −(180°Δ₂), and the total predetermined phase angle Δ=Δ₁+Δ₂ is between 0°˜90°; and
designing the reflective pattern.

21. The design method as claimed in claim 20, wherein the reflective pattern comprises a plurality of reflective units, each reflective unit comprises a major axis and a minor axis, the reflective units are equidistantly arranged along a first direction, and the minor axes of the reflective units are parallel to the first direction.

22. An antenna module, comprising:
a reflective superstrate;
an antenna substrate;
an antenna, disposed on the antenna substrate; and
a reflective pattern, formed on the reflective superstrate, wherein a reflection gap is formed between the reflective superstrate and the antenna substrate, the reflective pattern provides a first reflection phase angle, the antenna substrate provides a second reflection phase angle, the first reflection phase angle comprises a first determined phase angle Δ₁, the first determined phase angle Δ₁ is not 0°, the first reflection phase angle is about −(180°−Δ₁), the second reflection phase angle comprises a second determined phase angle Δ₂, the second reflection phase angle is about −(180°−Δ₂), a dimension of the reflection gap is directly proportional to a total predetermined phase angle Δ=Δ₁+Δ₂, and the total predetermined phase angle is between 0°˜90°.
